(19) United States
(12) Patent Application Publication
(10) Pub. No.: US 2001/0033788 A1
(43) Pub. Date: Oct. 25, 2001

(54) Dual multitran robot arm

(76) Inventor: Antonio F. Pietrantonio, Derry, NH (US)

Correspondence Address: PERMAN & GREEN, 425 POST ROAD, FAIRFIELD, CT, 06430, US

(21) Appl. No.: 09/863,775

(22) Filed: May 23, 2001

Related U.S. Application Data
(63) Continuation-in-part of application No. 09/145,928, filed on Sep. 3, 1998.

(51) Int. Cl. B66C 23/00

(52) U.S. Cl. 414/744.5

(57) ABSTRACT

Substrate transport apparatus comprises a coaxial drive shaft assembly including first, second, and third drive shafts which are independently rotatable about a common axis. A movable arm assembly includes first, second, and third upper arm members fixedly connected to the coaxial drive shaft assembly, the first upper arm member being fixedly connected to the first drive shaft, the second upper arm member being fixedly connected to the second drive shaft, and the third upper arm member being fixedly connected to the third drive shaft. A plurality of end effector devices are connected to the movable arm assembly for supporting substrates thereon, each of the end effector devices being movable individually between retracted and extended positions in response to movement of the upper arm members. First and second end effectors are positioned on a first side of the movable arm assembly and third and fourth end effectors are positioned on a second side of the movable arm assembly. Pairs of forearms pivotally join the upper arm members and each end effector, each of the end effectors being independently movable along a common path between retracted and extended positions. A plurality of substrate processing stations are provided around the common axis at discrete azimuthal locations; and the drive arms are rotated as a unit about the common axis, their operation stopped when the opposed end effectors are aligned with an associated processing station.

### BACKGROUND OF THE INVENTION

1. Field of the Invention

The present invention relates generally to a material transfer system and, more particularly, to a system for transporting material such as semiconductor wafers at a higher rate than previously known. The material transferred might include, but not be limited to, silicon and gallium arsenide semiconductor packaging substrates such as high density interconnects, semiconductor manufacturing process imaging plates such as masks or reticules and large area display panels such as active matrix LCD substrates.

2. Description of the Prior Art

The transfer of delicate silicon wafers or the like between a plurality of work stations or locations in the manufacture of semiconductor devices presents unique handling problems. The silicon wafers are very delicate and have highly polished surfaces. When the wafers are abruptly moved, they tend to slide. This sliding action can cause the silicon wafers to abrade or alternatively can cause damage to their edges if they collide.

There are numerous devices described in the prior art for transferring silicon wafers. For example:

U.S. Pat. No. 3,823,836 to Cheney et al. discloses an apparatus which includes a supply carrier with a plurality of ledges to hold the silicon wafers and a withdrawal device having a vacuum chuck. The vacuum chuck is attached to an elevator which raises and lowers the chuck. A horizontal transfer arm coupled to the vacuum chuck is used to transfer the silicon wafer from the supply carrier to a desired work station.

U.S. Pat. No. 3,730,595 to Yakubowski discloses a wafer transfer handling apparatus having an indexable carrier for transferring wafers to and from work stations. Wafers enter and leave the wafer carrier on an air slide with the aid of a wafer ejector acceptor arm having directional air jets. The wafer ejector acceptor arm controls the driving of the wafers into or out of the carrier from or onto the air slide which moves the wafers to or from a work station.

U.S. Pat. Nos. 4,062,463 to Hillman et al., 3,874,525 to Hassan et al., and 4,208,159 to Uehara et al. also disclose wafer transfer devices which include either pneumatic components or gripping devices for handling the wafers.

U.S. Pat. No. 5,431,529 to Eastman et al. discloses apparatus for transporting semiconductor wafers between spaced locations using articulated arms.

U.S. Pat. Nos. 4,666,366 to Davis, 4,909,701 to Hardegan et al., 5,180,276 to Hendrickson, and 5,647,724 to Davis, Jr. et al. all disclose wafer transfer handling apparatus having an articulated arm assembly which extends and retracts in a “froglike” motion to transfer an object such as a wafer between plurality of locations. Two articulated arms are operatively coupled such that when one arm is driven by a motor the articulated arms extend and retract in a “froglike” or “frogkick” type of motion. A platform is coupled to the arms and has the object to be transferred disposed thereon.

However the articulated arm assembly of such transfer apparatus can support only a single platform which limits through-put. Accordingly, there exists a need for a simple and reliable transfer device that will not damage the objects being transferred, and that is capable of increasing throughput with respect to the prior art devices.

It was with knowledge of the foregoing state of the technology that the present invention has been conceived and is now reduced to practice.

### SUMMARY OF THE INVENTION

The present invention relates to substrate transport apparatus which comprises a coaxial drive shaft assembly including first, second, and third drive shafts which are independently rotatable about a common axis. A movable arm assembly includes first, second, and third upper arm members connected to the coaxial drive shaft assembly, the first upper arm member being fixedly connected to the first drive shaft, the second upper arm member being fixedly connected to the second drive shaft, and the third upper arm member being fixedly connected to the third drive shaft. A plurality of end effector devices are connected to the movable arm assembly for supporting substrates thereon, each of the end effector devices being movable individually between retracted and extended positions in response to movement of the upper arm members. First and second end effectors are positioned on a first side of the movable arm assembly radially spaced from the common axis and third and fourth end effectors are positioned on a second side of the movable arm assembly radially spaced from the common axis. Pairs of forearms pivotally join the upper arm members and each end effector, each of the end effectors being independently movable along a common path between retracted and extended positions. A plurality of substrate processing stations are provided around the common axis at discrete azimuthal locations; and the drive arms are rotated as a unit about the common axis, their operation stopped when the opposed end effectors are aligned with an associated processing station.

A primary feature, then of the present invention is the provision of an improved material transfer system.

Another feature of the invention is the provision of such an improved material transfer system which serves to transport material such as semiconductor wafers at a higher rate than previously known. Still another feature of the invention is the provision of such an improved material transfer system which comprises a coaxial drive shaft assembly including first, second, and third drive shafts which are independently rotatable about a common axis.

Yet another feature of the invention is the provision of such an improved material transfer system which comprises a movable arm assembly including first, second, and third upper arm members fixedly connected to the coaxial drive shaft assembly, the first upper arm member being fixedly connected to the first drive shaft, the second upper arm member being fixedly connected to the second drive shaft, and the third upper arm member being fixedly connected to the third drive shaft.

A further feature of the invention is the provision of such an improved material transfer system which comprises a plurality of end effector devices connected to the movable arm assembly for supporting substrates thereon, each of the end effector devices being movable individually between retracted and extended positions in response to movement of the upper arm members.

Yet a further feature of the invention is the provision of such an improved material transfer system which comprises first and second end effectors positioned on a first side of the movable arm assembly and third and fourth end effectors are positioned on a second side of the movable arm assembly, opposite the first side.

Still a further feature of the invention is the provision of such an improved material transfer system which comprises pairs of forearms pivotally joining the upper arm members and each end effector, each of the end effectors being independently movable along a common path between retracted and extended positions.

Still another feature of the invention is the provision of such an improved material transfer system which comprises a plurality of substrate processing stations provided around the common axis at discrete azimuthal locations such that, as the drive arms are rotated as a unit about the common axis, their operation is stopped when the opposed end effectors are aligned with an associated processing station.

Other and further features, advantages, and benefits of the invention will become apparent in the following description taken in conjunction with the following drawings. It is to be understood that the foregoing general description and the following detailed description are exemplary and explanatory but are not to be restrictive of the invention. The accompanying drawings which are incorporated in and constitute a part of this invention, illustrate one of the embodiments of the invention, and together with the description, serve to explain the principles of the invention in general terms. Like numerals refer to like parts throughout the disclosure.

### BRIEF DESCRIPTION OF THE DRAWINGS

FIG. 1 is a diagrammatic top plan view of substrate processing apparatus utilizing substrate transport apparatus embodying the present invention;

FIG. 2 is a perspective view of the substrate transport apparatus of the invention;

FIG. 3 is a detail elevation view of the substrate transport apparatus of the invention;

FIG. 4 is a top plan view of the substrate transport apparatus of the invention;

FIG. 5 is a front elevation view of the substrate transport apparatus of the invention;

FIG. 6 is a side elevation view of the substrate transport apparatus of the invention; and

FIGS. 7A, 7B, 7C, 7D, and 7E are diagrammatic top plan views of the substrate transport apparatus of the invention and depicting different positions assumed by the apparatus.

### DETAILED DESCRIPTION OF THE PREFERRED EMBODIMENTS

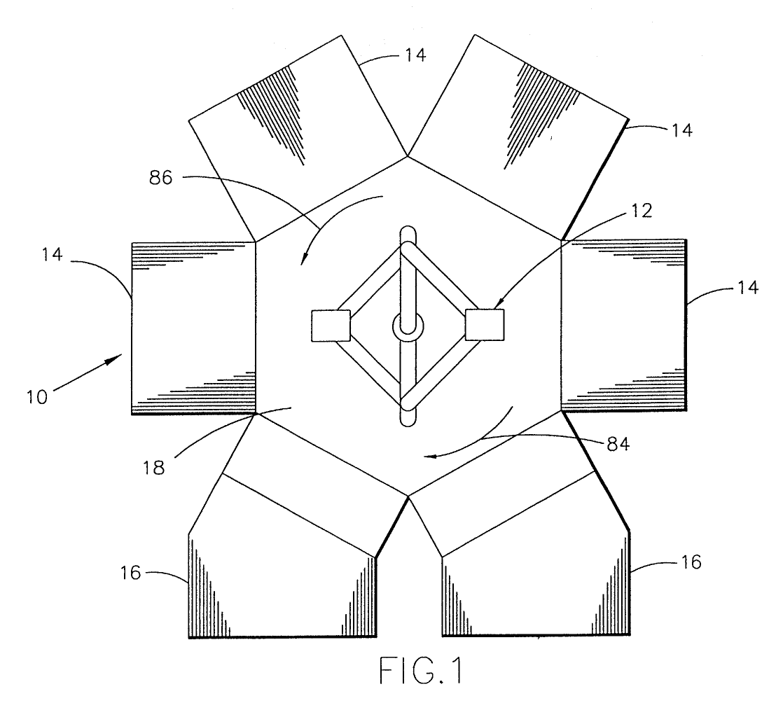

Turn now to the drawings and, initially, to FIG. 1 which generally illustrates, by way of a schematic top plan view, a substrate processing apparatus 10 having a substrate transport apparatus 12 incorporating features of the present invention. Although the present invention will be described with reference to the embodiments shown in the drawings. it should be understood that the present invention may be utilized in many forms of alternative embodiments. Also. any suitable size, shape or type of materials or elements may be used. In addition to the substrate transport apparatus 12, the substrate processing apparatus 10 includes multiple substrate processing chambers 14 and substrate cassette elevators 16 connected to a chamber 18. The transport apparatus 12 is located at least partially in the chamber 18 and is adapted to transport planar substrates such as semiconductor wafers or flat panel displays between and/or among the chambers 14 and elevators 16. In alternate embodiments, the transport apparatus 12 could be used in any suitable type of substrate processing apparatus.

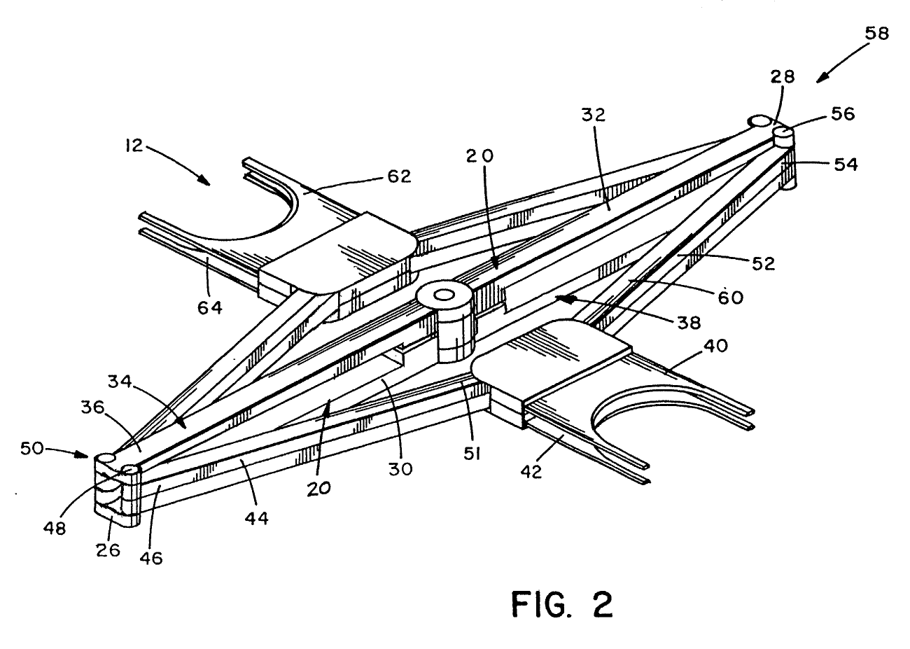

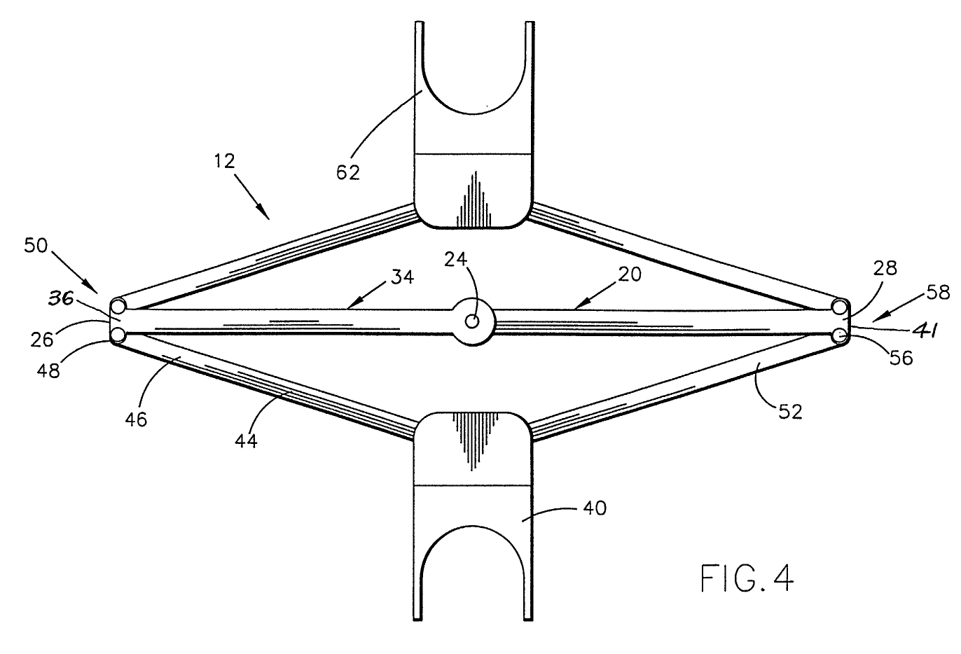

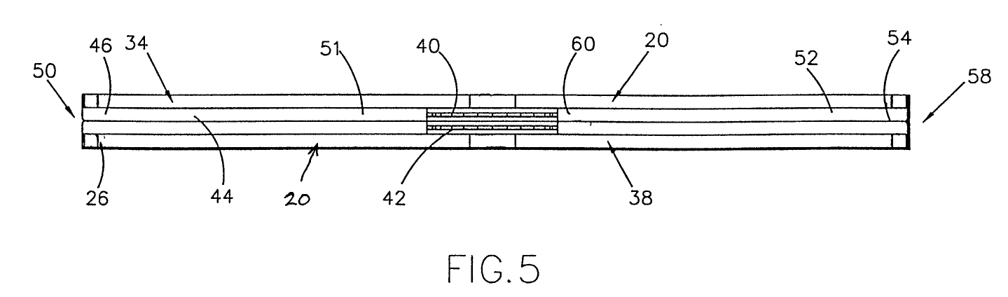

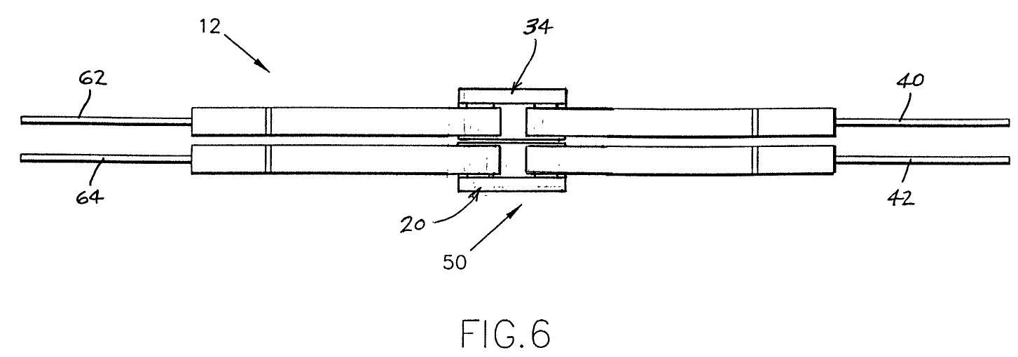

As earlier mentioned, the present invention relates primarily to the substrate transport apparatus 12 which will be the focus of the following disclosure. Turning now to FIGS. 2-6, the substrate transport apparatus 12, being illustrated in greater detail, is seen to include a first upper arm 20 mounted on a support member 22 so as to be rotatable about an upright axis 24. The first upper arm 20 extends radially from the upright axis 24 in opposite directions to left and right terminal ends, 26, 28, respectively. It will be noted that the portion 30 extending to the left terminal end 26 is offset along the axis 24 with respect to the portion 32 extending to the right terminal end 28. This offset serves to accommodate, to one side of the upright axis 24, a second upper arm 34 also mounted on the support member for rotation about the upright axis and extending radially therefrom to a left end 36 generally coincident with the left terminal end 26 of the first upper arm 20. In similar fashion, the offset of the first upper arm 20 to the side of the upright axis opposite the second upper arm 34 serves to accommodate a third upper arm 38 also mounted on the support member for rotation about the upright axis 24 and extending radially therefrom to a right end 41 generally coincident with the right terminal end 28 of the first upper arm 20.

Associated with the structure already described are first and second end effectors 40, 42, respectively, each being suitable for supporting a substrate thereon in a known manner. Associated pairs of forearms serve to connect the end effectors 40, 42 to the upper arms 20, 34, and 38. More specifically, for the end effector 40 and its associated one of these pairs of forearms, a left forearm 44 (see especially FIG. 2) has a left end 46 pivotally connected by means of a suitable fastener 48 and a bearing pair to the second upper arm 34 at its left end. This connection defines a left elbow 50 of the transport apparatus 12. A right end 51 of the left forearm 44 is pivotally connected to the end effector 40. In similar fashion, a right forearm 52 has a right end 54 pivotally connected to the first upper arm 20 at its right end by means of a suitable fastener 56 and bearing pair, thereby defining a right elbow 58. A left end 60 of the right forearm 52 is pivotally connected to the end effector 40. A similar construction is provided for the left and right forearms (unnumbered) connected to the end effector 42. That is, end effector 42 is connected to first upper arm 20 and to third upper arm 38 via the left and right forearms (unnumbered), respectively.

Third and fourth end effectors 62, 64, respectively, are coplanar and oppositely aligned with the first and second end effectors 40, 42. The first and second end effectors 40, 42 are positioned so as to be radially spaced from the upright axis 24 in one direction and the third and fourth end effectors 62, 64 are positioned so as to be radially spaced from the upright axis 24 in the opposite direction. As with the first and second end effectors, the third and fourth end effectors 62, 64 are similarly connected to the upper arms 20, 34, 38 by means of third and fourth pairs of forearms (unnumbered). Each of the third and fourth pairs of forearms includes a left forearm having a left end pivotally connected to the second and first upper arms at their left ends and a right end pivotally connected to the third and fourth end effectors, respectively. Similarly, each of the third and fourth pairs of forearms also includes a right forearm having a right end pivotally connected to the first and third upper arms at their right ends and a left end pivotally connected to the third and fourth end effectors at their left ends, respectively. That is, end effector 62 is connected to second upper arm 34 and to first upper arm 20 via the left and right forearms (unnumbered), respectively. Also, end effector 64 is connected to first upper arm 20 and to third upper arm 38 via the left and right forearms (unnumbered), respectively.

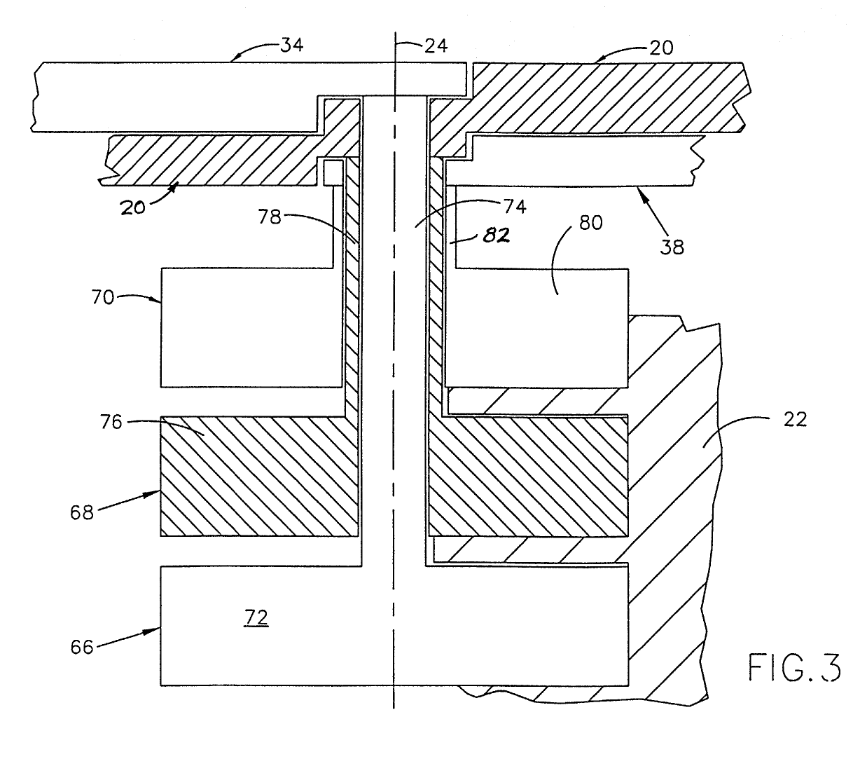

As best illustrated in FIG. 3, there are three drive mechanisms for operating the end effectors 40, 42, 62, and 64 and their associated arm assemblies. To this end, a first drive mechanism 68 mounted on the support member 22 serves to rotate the first upper arm 20 about the upright axis 24 selectively either in the clockwise direction or in the counterclockwise direction. Independently of the first drive mechanism 68, a second drive mechanism 66 is also mounted on the support member 22 and serves to rotate the second upper arm 34 about the upright axis 24 selectively either in the clockwise direction or in the counterclockwise direction. Finally, and independently of the first and second drive mechanisms 68, 66, a third drive mechanism 70 is also mounted on the support member 22 and serves to rotate the third upper arm 38 about the upright axis 24 selectively either in the clockwise direction or in the counterclockwise direction. The drive mechanism 66 includes a motor 72 and associated drive shaft 74 aligned with the upright axis 24 and suitably joined to the second upper arm 34 to effect rotation of the second upper arm about the upright axis. In a similar manner, the drive mechanism 68 includes a motor 76 and associated drive shaft 78 aligned with the upright axis 24 and suitably joined to the first upper arm 20 to effect rotation of the first upper arm about the upright axis. Finally, in another similar manner, the drive mechanism 70 includes a motor 80 and associated drive shaft 82, again aligned with the upright axis 24 and suitably joined to the third upper arm 38 to effect rotation of the third upper arm about the upright axis.

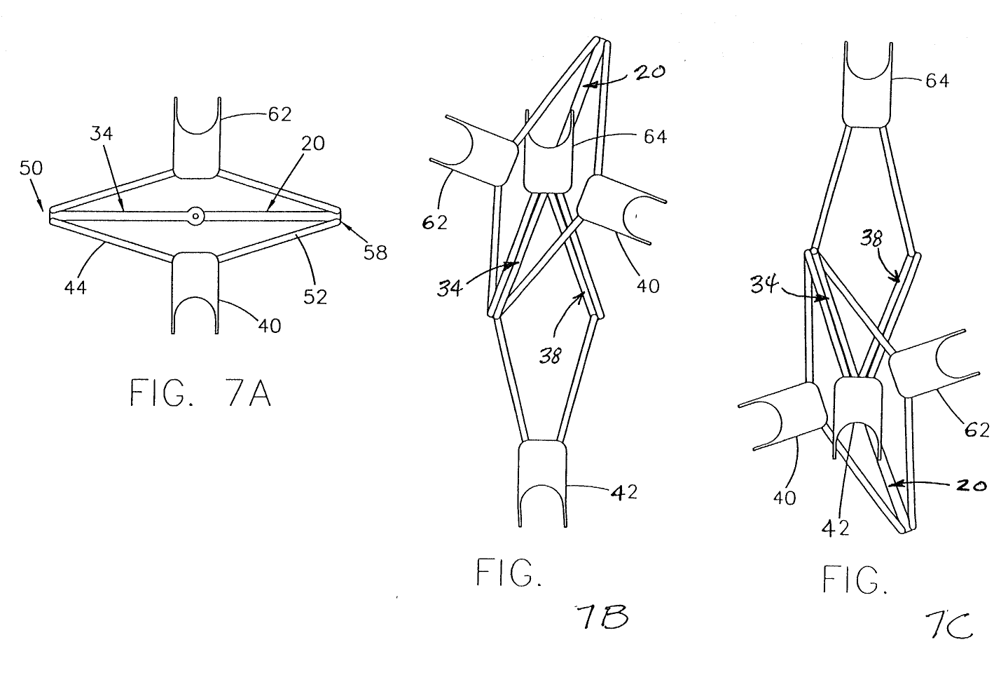

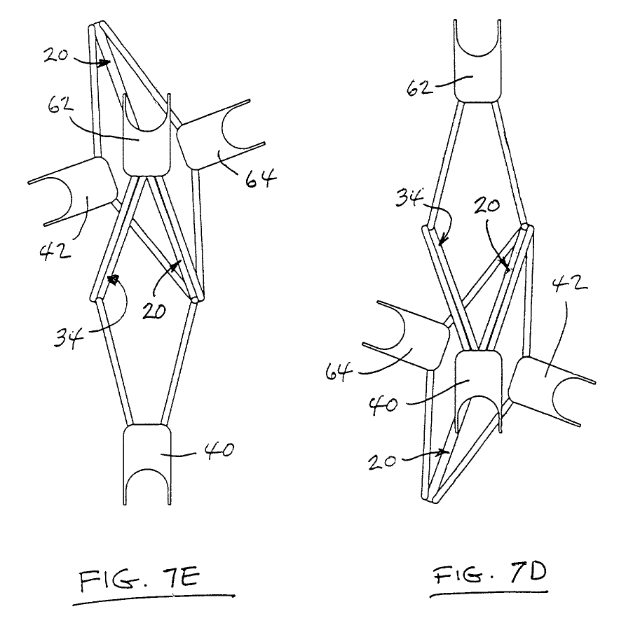

Viewing FIGS. 7A-7E, the motors 72, 76, and 80 can be operated in a variety of combinations to effect the desired movements of their associated end effectors. For example, from a quiescent state illustrated in FIG. 7A, operation of the first and second drive mechanisms 68, 66 in the counterclockwise direction and of the third drive mechanism 70 in the clockwise direction (see FIG. 7B) causes the second end effector 42 to move from a retracted position to an extended position. In another instance, as seen in FIG. 7C, operation of the first and second drive mechanism 68, 66 in the clockwise direction and of the third drive mechanism 70 in the counterclockwise direction causes the fourth end effector 64 to move from a retracted position to an extended position. In still another instance as seen in FIG. 7D, operation of the second drive mechanism 66 in the clockwise direction and the first and third drive mechanisms 68 and 70 in the counterclockwise direction causes the third end effector 62 to move from a retracted position to an extended position. In yet another instance as seen in FIG. 7E, operation of the first drive mechanism 68 in the clockwise direction and the second drive mechanism 66 in the counterclockwise direction and of the third drive mechanism 70 in the clockwise direction causes the first end effector 40 to move from a retracted position to an extended position. In yet a further instance, operation of the first, second, and third drive mechanisms in unison in the clockwise direction causes the first, second, third, and fourth end effectors 40, 42, 62, 64 to rotate in the clockwise direction (as indicated by arrow 84 in FIG. 1) while operation of the first, second, and third drive mechanisms in unison in the counterclockwise direction (as indicated by arrow 86 in FIG. 1) causes the first, second, third, and fourth end effectors 40, 42, 62, 64 to rotate in the counterclockwise direction.

This operation may be better understood by viewing the relationships presented in Table 1 below.

TABLE 1

| | MOTOR | MOTOR | MOTOR | |
|---|---|---|---|---|
| | 76 | 72 | 80 | |
| | 1^{st} D.M. | 2^{nd} D.M. | 3^{rd} D.M. | |
| | 68 | 66 | 70 | |
| | 1^{st} U.A. | 2^{nd} U.A. | 3^{rd} U.A. | |
| CONDITION | 20 | 34 | 38 | RESULTS |
| 1 (FIG. 7B) | CCW* | CCW | CW* | End effector 42 |
| | | | | extends |
| 2 (FIG. 7C) | CW | CW | CCW | End effector 64 |
| | | | | extends |
| 3 (FIG. 7D) | CCW | CW | CCW | End effector 62 |
| | | | | extends |
| 4 (FIG. 7E) | CW | CCW | CW | End effector 40 |
| | | | | extends |
| 5 | CW | CW | CW | Transport apparatus |
| | | | | 12 rotates CW |
| 6 | CCW | CCW | CCW | Transport apparatus |
| | | | | 12 rotates CCW |

*CCW = counterclockwise
**CW = clockwise

While preferred embodiments of the invention have been disclosed in detail, it should be understood by those skilled in the art that various other modifications may be made to the illustrated embodiments without departing from the scope of the invention as described in the specification and defined in the appended claims.

What is claimed is:

1. A substrate transport apparatus comprising:
a coaxial drive shaft assembly including a first drive shaft, a second drive shaft, and a third drive shaft, said first, second, and third drive shafts being independently rotatable about a common axis;
a movable arm assembly including first, second, and third upper arm members fixedly connected to said coaxial drive shaft assembly, said first upper arm member being fixedly connected to said first drive shaft, said second upper arm member being fixedly connected to said second drive shaft, and said third upper arm member being fixedly connected to said third drive shaft; and
a set of four end effector units connected to said movable arm assembly for supporting substrates thereon, each of said end effector units being movable individually between retracted and extended positions in response to movement of said upper arm members.

2. A substrate transport apparatus as set forth in claim 1
wherein said set of four end effector units includes:
first and second end effectors on a first side of said movable arm assembly radially spaced from the common axis and opposite the first side; and
third and fourth end effectors on a second side of said movable arm assembly radially spaced from the common axis and opposite the second side; and
wherein said movable arm assembly includes a first pair of forearms extending between and pivotally joining, respectively, said first and second upper arm members and said first end effector;
wherein said movable arm assembly includes a second pair of forearms extending between and pivotally joining, respectively, said third and first upper arm members and said second end effector;
wherein said movable arm assembly includes a third pair of forearms extending between and pivotally joining, respectively, said second and first upper arm members and said third end effector; and
wherein said movable arm assembly includes a fourth pair of forearms extending between and pivotally joining, respectively, said first and third upper arm members and said fourth end effector;
each of said first, second, third, and fourth end effectors being individually movable radially toward and away from the common axis between retracted and extended positions.

3. A substrate transport apparatus as set forth in claim 1
wherein said first upper arm member extends radially from said first drive shaft in opposite directions to left and right opposed first terminal ends;
wherein said second upper arm member extends radially from said second drive shaft to a second terminal end;
wherein said third upper arm member extends radially from said third drive shaft to a third terminal end;
wherein said left terminal end of said first upper arm member and said terminal end of said second upper arm member are pivotally joined at a left elbow member; and
wherein said right terminal end of said first upper arm member and said terminal end of said third upper arm member are pivotally joined at a right elbow member.

4. A substrate transport apparatus as set forth in claim 3
wherein said set of four end effector units includes:
first and second end effectors on a first side of said movable arm assembly radially spaced from the common axis and opposite the first side; and
third and fourth end effectors on a second side of said movable arm assembly radially spaced from the common axis and opposite the second side; and
wherein said movable arm assembly includes:
a first pair of forearms pivotally joining, respectively, said first end effector and said left and right elbow members;
a second pair of forearms pivotally joining, respectively, said second end effector and said left and right elbow members;
a third pair of forearms pivotally joining, respectively, said third end effector and said left and right elbow members; and
a fourth pair of forearms pivotally joining, respectively, said fourth end effector and said left and right elbow members.

5. A substrate transport apparatus as set forth in claim 2 including:
a plurality of substrate processing stations around the common axis at discrete azimuthal locations, said first, second, and third upper arm members being rotatable as a unit about the common axis and, when rotation is terminated, each of said first, second, third, and fourth end effectors is aligned with an associated one of said processing stations, respectively.

6. A substrate transport apparatus as set forth in claim 5 including:
first drive means for selectively rotating said first upper arm member in a counterclockwise direction;
second drive means for selectively rotating said first second arm member in a counterclockwise direction; and
third drive means for selectively rotating said third upper arm member in a clockwise direction;
whereby said first end effector moves to the extended position while said second, third, and fourth end effectors remain in their respective retracted positions.

7. A substrate transport apparatus as set forth in claim 5 including:
first drive means for selectively rotating said first upper arm member in a clockwise direction;
second drive means for selectively rotating said first second arm member in a clockwise direction; and
third drive means for selectively rotating said third upper arm member in a counterclockwise direction;
whereby said third end effector moves to the extended position while said first, second, and fourth end effectors remain in their respective retracted positions.

8. A substrate transport apparatus as set forth in claim 5 including:
first drive means for selectively rotating said first upper arm member in a clockwise direction;
second drive means for selectively rotating said first second arm member in a counterclockwise direction; and
third drive means for selectively rotating said third upper arm member in a counterclockwise direction;
whereby said second first end effector moves to the extended position while said first, third, and fourth end effectors remain in their respective retracted positions.

9. A substrate transport apparatus as set forth in claim 5 including:
first drive means for selectively rotating said first upper arm member in a clockwise direction;
second drive means for selectively rotating sad first second arm member in a clockwise direction; and
third drive means for selectively rotating said third upper arm member in a counterclockwise direction;
whereby said fourth end effector moves to the extended position while said first, second, and third end effectors remain in their respective retracted positions.

10. A substrate transport apparatus as set forth in claim 5
wherein said first and second end effectors overlie one another in the retracted position; and
wherein said third and fourth end effectors overlie one another in the retracted position.

11. A substrate transport apparatus as set forth in claim 1 including:
a first motor for driving said first drive shaft;
a second motor for driving said second drive shaft; and
a third motor for driving said third drive shaft.

12. A substrate transport apparatus comprising:
a first upper arm mounted on a support rotatable about an upright axis and extending radially therefrom in opposite directions to left and right ends thereof;
a second upper arm mounted on the support rotatable about the upright axis and extending radially therefrom to a left end thereof;
a third upper arm mounted on the support rotatable about the upright axis and extending radially therefrom to a right end thereof;
first and second end effector means for supporting substrates thereon;
first and second pairs of forearms, each of said first and second pairs of forearms including a left forearm having a left end pivotally connected to said first and second upper arms at said left ends thereof and a right end pivotally connected to said first and second end effector means, respectively, each of said first and second pairs of forearms including a right forearm having a right end pivotally connected to said first and third upper arms at said right ends thereof and a left end pivotally connected to said first and second end effector means, respectively;
first drive means for rotating said first upper arm about the upright axis selectively either in the clockwise direction or in the counterclockwise direction;
second drive means for rotating said second upper arm about the upright axis selectively either in the clockwise direction or in the counterclockwise direction;
third drive means for rotating said third upper arm about the upright axis selectively either in the clockwise direction or in the counterclockwise direction;
whereby operation of said first and second drive means in the counterclockwise direction and of said third drive means in the clockwise direction causes said first end effector means to move from a retracted position to an extended position and said second end effector means to move from an extended position to a retracted position;
whereby operation of said first drive means in the clockwise direction and of said second and third drive means in the counterclockwise direction causes said second end effector to move from a retracted position to an extended position and said first end effector means to move from an extended position to a retracted position;
whereby operation of said first, second, and third drive means in unison in the clockwise direction causes said first, second, and third upper arms to rotate in the clockwise direction; and
whereby operation of said first, second, and third drive means in unison in the counterclockwise direction causes said first, second, and third upper arms to rotate in the counterclockwise direction.

13. A substrate transport apparatus as set forth in claim 12 including:
third and fourth end effector means coplanar and oppositely aligned with said first and second end effector means for supporting substrates thereon; and
third and fourth pairs of forearms, each of said third and fourth pairs of forearms including a left forearm having a left end pivotally connected to said first and second upper arms at said left ends thereof and a right end pivotally connected to said first and third end effector means, respectively, each of said third and fourth pairs of forearms including a right forearm having a right end pivotally connected to said first and second upper arms at said right ends thereof and a left end pivotally connected to said second and third end effector means at said left ends thereof, respectively.

14. A method of transporting substrates into and out of processing chambers in a substrate processing apparatus, the method comprising the steps of:
(a) mounting first, second, and third drive arms of a movable arm assembly for independent rotation about a common axis;
(b) providing a first pair of end effectors on a first side of the movable arm assembly;
(c) providing a second pair of end effectors on a second side of the movable arm assembly opposite the first side, the end effectors being independently movable along a common path between retracted and extended positions;
(d) rotating the first, second, and third drive arms about the common axis; and
(e) moving the end effectors along the common path between their respective retracted and extended positions as the first, second, and third drive arms are moved as a result of step (d).

15. A method as set forth in claim 14 including the steps of:
(f) providing a plurality of substrate processing stations around the common axis at discrete azimuthal locations; and
(g) selectively rotating the first, second, and third drive arms as a unit about the common axis; and
(h) terminating step (g) while aligning the first pair of end effectors and the second pair of end effectors with associated processing stations, respectively.

16. A method as set forth in claim 15 wherein step (g) includes the steps of:
(i) in one instance, rotating the first, second, and third drive arms as a unit about the common axis in the clockwise direction; and
(j) in another instance, rotating the first, second, and third drive arms as a unit about the common axis in the counterclockwise direction.

17. A method as set forth in claim 14
wherein the first pair of end effectors of step (b) includes first and second end effectors;
wherein the second pair of end effectors of step (c) includes third and fourth end effectors;
wherein step (d) includes the steps of:
(f) rotating the first drive arm in the counterclockwise direction;
(g) rotating the second drive arm in the counterclockwise direction;
(h) rotating the third drive arm in the clockwise direction;
whereby the first end effector moves to the extended position while the second, third, and fourth end effectors remain in their respective retracted positions.

18. A method as set forth in claim 14
wherein the first pair of end effectors of step (b) includes first and second end effectors;
wherein the second pair of end effectors of step (c) includes third and fourth end effectors;
wherein step (d) includes the steps of:
(f) rotating the first drive arm in the clockwise direction;
(g) rotating the second drive arm in the clockwise direction;
(h) rotating the third drive arm in the counterclockwise clockwise direction;
whereby the third end effector moves to the extended position while the first, second, and fourth end effectors remain in their respective retracted positions.

19. A method as set forth in claim 14
wherein the first pair of end effectors of step (b) includes first and second end effectors;
wherein the second pair of end effectors of step (c) includes third and fourth end effectors;
wherein step (d) includes the steps of:
(f) rotating the first drive arm in the clockwise direction;
(g) rotating the second drive arm in the counterclockwise direction;
(h) rotating the third drive arm in the counterclockwise direction;
whereby the second end effector moves to the extended position while the first, third, and fourth end effectors remain in their respective retracted positions.

20. A method as set forth in claim 14
wherein the first pair of end effectors of step (b) includes first and second end effectors;
wherein the second pair of end effectors of step (c) includes third and fourth end effectors;
wherein step (d) includes the steps of:
(f) rotating the first drive arm in the clockwise direction;
(g) rotating the second drive arm in the clockwise direction;
(h) rotating the third drive arm in the counterclockwise direction;
whereby the fourth end effector moves to the extended position while the first, second, and third end effectors remain in their respective retracted positions.
